(19) United States
(12) Patent Application Publication
(10) Pub. No.: US 2020/0098247 A1
(43) Pub. Date: Mar. 26, 2020

(54) WEARABLE BRACELET TRACKING SYSTEM

(71) Applicant: Gwendolyn Moore, Brooklyn, NY (US)

(72) Inventor: Gwendolyn Moore, Brooklyn, NY (US)

(21) Appl. No.: 16/139,522

(22) Filed: Sep. 24, 2018

(51) Int. Cl. G08B 25/01

(52) U.S. Cl. CPC G08B 25/016

(57) ABSTRACT

A wearable bracelet tracking system, including a transmitter bracelet, including a microprocessor to process a signal received by the transmitter bracelet, a plurality of alarm lights disposed around the transmitter bracelet to be turned on in response to the received signal, and a speaker disposed on the transmitter bracelet to sound an alarm in response to the received signal, and a receiver bracelet, including an emergency button disposed on an outer surface of the receiver bracelet to be depressed by a user, and a microprocessor to generate and to transmit the signal to the transmitter bracelet in response to the depression of the emergency button.

### BACKGROUND

### 1. Field

The present general inventive concept relates generally to a tracking system, and particularly, to a wearable bracelet tracking system.

### 2. Description of the Related Art

According to the National Center for Missing and Exploited Children, over 250,000 children are abducted in the United States every year, and tens of thousands more are subject to abuse, bullying and other crimes. But once a child leaves home in the morning, the average parent has little or no way of monitoring that child's situation or of helping the child should he/she get into trouble.

Therefore, there is a need for a system to help track and monitor a child's location.

### SUMMARY

The present general inventive concept provides a wearable bracelet tracking system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wearable bracelet tracking system, including a transmitter bracelet, including a microprocessor to process a signal received by the transmitter bracelet, a plurality of alarm lights disposed around the transmitter bracelet to be turned on in response to the received signal, and a speaker disposed on the transmitter bracelet to sound an alarm in response to the received signal, and a receiver bracelet, including an emergency button disposed on an outer surface of the receiver bracelet to be depressed by a user, and a microprocessor to generate and to transmit the signal to the transmitter bracelet in response to the depression of the emergency button.

The transmitter bracelet may further include a GPS transmitter to transmit a location of the transmitter bracelet to the receiver bracelet, and the receiver bracelet may further include a GPS receiver to receive the location of the transmitter bracelet.

The location of the transmitter bracelet may be sent to a mobile device from at least one of the transmitter bracelet and the receiver bracelet.

The mobile device may include a display unit to display a map and a dot depicting a location of the transmitter bracelet on the map.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an angled perspective view of a wearable bracelet tracking system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

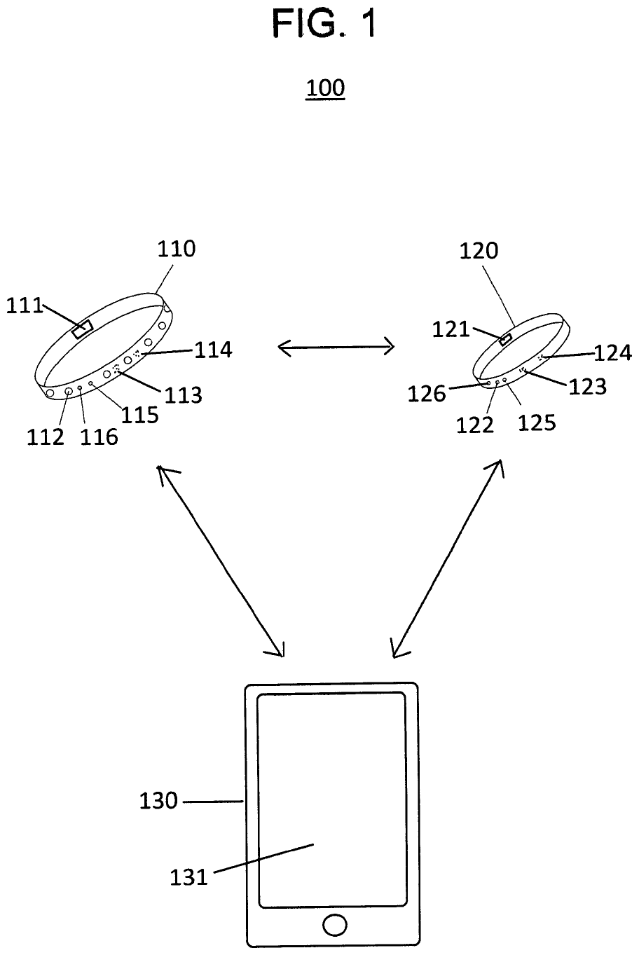

FIG. 1 illustrates an angled perspective view of a wearable bracelet tracking system 100, according to an exemplary embodiment of the present general inventive concept.

The wearable bracelet tracking system 100 may include a receiver bracelet 110, a transmitter bracelet 120, and a mobile device 130.

The receiver bracelet 110 may be designed to be worn by a parent, while the transmitter bracelet 120 may be designed to be worn by a child.

The receiver bracelet 110, the transmitter bracelet 120, and the mobile device 130 may all be mutually communicable and/or paired together using cellular technology, WIFI, the Internet, an Intranet, 3G, 4G, BLUETOOTH, near-field communications, WIFI Direct, etc., but are not limited thereto.

The mobile device 130 may include any type of mobile device that may download and execute programs and/or applications, including, but not limited to, a cellular telephone, a laptop computer, a smart watch, a desktop computer, a tablet computer, etc.

The receiver bracelet 110 may include a microprocessor 111, a plurality of alarm lights 112, a speaker 113, a microphone 114, a GPS receiver 115, and a communication button 116, but is not limited thereto.

The transmitter bracelet 120 may include a microprocessor 121, an emergency button 122, a speaker 123, a microphone 124, a GPS transmitter 125, and a communication button 126, but is not limited thereto.

The receiver bracelet 110 and the transmitter bracelet 120 may also include components of the other one of the transmitter bracelet 120 and the receiver bracelet 110, respectively.

The microprocessor 111 may be designed to power and control the other components of the receiver bracelet 110, may allow connection between the receiver bracelet 110 and the Internet and other devices, may process signals received by the transmitter bracelet 120, may send signals to the mobile device 130, and may include a battery that may be recharged with a USB cable.

The plurality of lights 112 may be turned on and/or may perform a lighting function when the microprocessor 111 receives a signal from the transmitter bracelet 120 that the emergency button 122 has been depressed. The plurality of lights 112 may be any type of lights, including, but not limited to LEDs, plasma bulbs, etc. Also, the plurality of lights 112 may perform lighting functions including flash, strobe, blink, pulse, fade, or any other lighting function, and may be any color known to one of ordinary skill in the art.

The speaker 113 may emit an alarm when the microprocessor 111 receives a signal from the transmitter bracelet 120 that the emergency button 122 has been depressed.

The speaker 113 and the microphone 114 may be used to allow a parent to communicate (i.e., conduct a real-time conversation) with a child wearing the transmitter bracelet 120, when the communication button 116 has been depressed.

The GPS receiver 115 may allow the receiver bracelet 110 to track where the transmitter bracelet 120 is located. If the receiver bracelet 110 is paired with and/or in communication with the mobile device 130, the mobile device 130 may display, on a display unit 131, a map with a dot denoting where the transmitter bracelet 120 is located, based on the signal received by the receiver bracelet 110 from the transmitter bracelet 120. In other words, the receiver bracelet 110 may send the signal received from the transmitter bracelet 120 to the mobile device 130 for processing and use.

Regarding the transmitter bracelet 120, the microprocessor 121 may be designed to power and control the other components of the transmitter bracelet 120, may allow connection between the transmitter bracelet 120 and the Internet and other devices, may send signals to the receiver bracelet 110, may send signals to the mobile device 130, and may include a battery that may be recharged with a USB cable.

The emergency button 122 may be disposed on an outer (outside) surface of the transmitter bracelet 120, and may be depressed when a wearer of the transmitter bracelet (e.g., a child) is in danger or is experiencing an emergency. This depression of the emergency button 122 may cause the microcontroller 121 to send a signal to the receiver bracelet 110 to cause the plurality of lights 112 on the receiver bracelet 110 to flash, and the speaker 113 on the receiver bracelet 110 to sound/emit an alarm.

The speaker 123 may emit an alarm when the microprocessor 121 receives a signal from the transmitter bracelet 120 that the emergency button 122 has been depressed.

The speaker 123 and the microphone 124 may be used to allow a child to communicate (i.e., conduct a real-time conversation) with a parent wearing the receiver bracelet 110, when the communication button 126 has been depressed.

The GPS transmitter 125 may allow the receiver bracelet 110 to track where the transmitter bracelet 120 is located. If the transmitter bracelet 120 is paired with and/or in communication with the mobile device 130, the mobile device 130 may display, on the display unit 131, a map with a dot denoting where the transmitter bracelet 120 is located, based on a signal received by the mobile device 130 directly from the transmitter bracelet 120.

Additionally, the receiver bracelet 110 may include a vibrating mechanism to allow the receiver bracelet 110 to vibrate in response to a signal (e.g., an emergency signal) received from the transmitter bracelet 120.

Although the wearable bracelet tracking system 100 as described above and as illustrated in FIG. 1 has specifically depicted bracelets, the same system 100 may be applied to ankle bracelets, rings, necklaces, earrings, etc., and therefore, the present general inventive concept is not limited to bracelets.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wearable bracelet tracking system, comprising:
a receiver bracelet, comprising:
a microprocessor to process a signal received by the receiver bracelet,
a plurality of alarm lights disposed around the receiver bracelet to be turned on in response to the received signal, and
a speaker disposed on the receiver bracelet to sound an alarm in response to the received signal; and
a transmitter bracelet, comprising:
an emergency button disposed on an outer surface of the transmitter bracelet to be depressed by a user, and
a microprocessor to generate and to transmit the signal to the receiver bracelet in response to the depression of the emergency button.

2. The wearable bracelet tracking system of claim 1, wherein:
the transmitter bracelet further comprises a GPS transmitter to transmit a location of the transmitter bracelet to the receiver bracelet; and
the receiver bracelet further comprises a GPS receiver to receive the location of the transmitter bracelet.

3. The wearable bracelet tracking system of claim 1, wherein the location of the transmitter bracelet is sent to a mobile device from at least one of the transmitter bracelet and the receiver bracelet.

4. The wearable bracelet tracking system of claim 3, wherein the mobile device comprises a display unit to display a map and a dot depicting a location of the transmitter bracelet on the map.
